(19) United States
(12) Patent Application Publication
(10) Pub. No.: US 2004/0017734 A1
(43) Pub. Date: Jan. 29, 2004

(54) Clock device with pendulum producing visual effect

(76) Inventor: Hendrik Stallinga, Amsterdam (NL)

Correspondence Address: Richard L. Strauss, Esq., 2492 Oceanside Road, Oceanside, NY, 11572, US

(21) Appl. No.: 10/207,606

(22) Filed: Jul. 29, 2002

(51) Int. Cl. G04C 17/00; G04B 19/00; G04B 25/00

(52) U.S. Cl. 368/223

(57) ABSTRACT

A pendulum clock is disclosed wherein said clock incorporates a flexible pendulum not incorporating a pendulum weight, so as to produced curved pendulum patterns. In a preferred embodiments, a pendulum is disclosed utilizing an electrically powered clockworks which utilizes a electromagnetic pendulum drive in order to operate a flexible plumbless pendulum suspended therebelow so as to provide a curved pendulum conformation, such as, for example, a sigmoid pattern during clock operation.

### TECHNICAL FIELD

The present invention relates generally to the field of clocks and other timepieces. More particularly, the present invention relates to a clock producing a visual effect by means of a specifically configured pendulum.

### BACKGROUND OF THE INVENTION

Clocks have long been known to utilize pendulums as regulatory devices. Typically, pendulums have been comprised of an elongated stem having, proximal to a superior terminus, a pivoting means of attachment to a clockworks. The pivoting attachment typically includes an especially configured “anchor” portion which limits, controls the rate of revolution of, and meshes with an escapement gear. The escapement gear, accurately controlled by the pendulum, in turn engages and operates clockwork gears in order to provide accurate movement of hour and minute hands. The escapement gear is typically powered, via a series of gears, by suspended weights or a spring motor (also referred to as a main spring). The spring motor/main spring or weights therefore provide power to operate the escapement controlled clockworks as well as imparting enough force to the pendulum to maintain its movement so as to act as a pendulum drive.

The period of the pendulum—the time the pendulum requires to complete one arc and return to its original position, is the key to clock accuracy. The length of the pendulum controls the period. Just proximal to an inferior terminus of the pendulum stem, a pendulum (or plumb) weight is adjustably affixed in a distal/proximal manner so as to enable the pendulum's period to be adjusted. More specifically, moving the pendulum weight in a distal direction, towards the inferior terminus of the stem, will have the effect of increasing the period of the arc of movement through which the pendulum moves. The speed of the pendulum drive means to which the pendulum is operatively connected will accordingly slow in response to the increased arc and thereby slow down the rate of the clock. Conversely, moving the pendulum weight to a more proximal (or superior) position has the effect of decreasing the period of movement so as to speed up the movement of the clock. In this manner the pendulum may be utilized to correct clock works that are running to slow or fast.

Modern electronic technology has, in many instances, replaced mechanical clock work regulators, such as pendulums and balance wheels, with solid state timing devices such as, for example, quartz movements. Clocks utilizing such advanced electronic clock work regulation, do not require the use of conventional pendulums. However, such clocks often do retain such devices solely for the purpose of visual display. In such instances, the pendulums do not ordinarily include any adjustable weight or plumb as these devices serve as “decorative” devices only and are themselves regulated by the clockworks. Typically, such pendulums incorporate a magnetized material, such as a ferrite magnet, affixed to a portion of the pendulum stem. Wire coils, placed within a clockworks housing, and in close approximation with arc traversed by the decorative pendulum are utilized to both sense the position of the pendulum—through a given arc—and to provide, via the repulsion and attraction of electromagnetism, movement mimicking the action of a regulatory pendulum. In such instances the clock works, via an electronic regulator (e.g. a quartz crystal), causes the pendulum to move through a consistent and chosen arc period such as, e.g. 1-2 cycles per second.

The arc produced by the aforementioned pendulums is best described as originating from a superior pivot point, proximal to the clock works to which they are mounted, and creating a linear sweep from that point to all of the positions of the arc. In designing regulatory pendulums, flexion of the pendulum stem is not desirable from either a functional or “authentic reproduction” standpoint. Such flexion would interfere with the production of a true arc capable of producing consistent regulatory periods. However, if flexible stem materials were selected for such regulatory pendulums (or non-functional facsimiles thereof), it would be necessary to incorporate a pendulum (or “plumb”) weight in order to assure the production of a true radial sweep from the pivot point to all points of the arc created thereby.

### SUMMARY OF THE INVENTION

Now in accordance with the present invention, a pendulum clock is disclosed wherein a flexible pendulum—not having a pendulum weight—is utilized to produce a desired curved conformation during clock operation. The length and weight of the pendulum is especially configured and adapted so as to produce the particular curved (non-linear) conformation desired during clock operation. Said length and weight of the pendulum may be especially selected to create, for example, an “S” (or sigmoid) curve during pendulum operation.

The pendulum clock of the present invention may utilize, for example, any conventional clockworks having a pendulum drive—including regulatory pendulum drives and purely decorative (non-regulatory) drives in which the clock works controls the pendulum operation (and period). The term “regulatory pendulum drive” as used throughout this specification and claims refers to those clocks in which the pendulum is utilized to regulate the speed of the clock works as a means of adjusting timepiece accuracy. The term “non-regulatory pendulum drive” and “decorative pendulum drive” are interchangeable and both refer to those clocks which utilize a pendulum as a visual display and wherein the pendulum does not, in fact, regulate clock speed or accuracy. The clockworks selected may utilize a mechanical power means wherein a spring motor or weights is utilized for powering (and storage of power) for the clock. The clockworks selected may also be electronic and utilize electricity as a power source. However, it is preferred that the clockworks utilized in the present invention incorporates a non-regulatory pendulum drive regulated by the clockworks. For example, an electrically powered clockworks, incorporating quartz crystal time regulation is most advantageously selected. It is further advantageous if such a clockworks includes an electromagnetic pendulum drive system for operation of the flexible pendulum although such is not required for all embodiments herein.

As mentioned above, the pendulum must be a flexible structure or, as discussed in greater detail below in regard to embodiments utilizing regulatory pendulum drives, the pendulum must comprise a flexible portion. Such flexibility may be provided, for example, by utilizing a metal or plastic chain as the pendulum. In such instances the chain may be configured as, for example, of a ball, open or closed link chain. The pendulum may also be fabricated of a rope, cord, line or string comprised of a natural or synthetic material such as, for example, hemp, acrylic or nylon. However, regardless of material or configuration utilized, the pendulum utilized in accordance with the present invention must be free of any pendulum weight or plumb device as utilized in the prior art—it must be a plumbless pendulum. The term “plumbless”, “plumbless pendulum” and “plumbless stem” as utilized throughout the specification and claims refers to a pendulum, in accordance with the present invention, which is devoid of any attached, adjustable or integral weight element. Such weight elements utilized in the prior art as means of adjusting a pendulum's period, are not utilized in the present inventions since, as discussed below, such weights would interfere with the production of a curved pendulum shape and are otherwise unnecessary for a pendulum that is not regulatory in nature or function. However, a clockworks utilized in practicing the present invention can advantageously include a ferrite “blob” or magnet mounted upon or integral within the pendulum drive stem. The terms “pendulum drive stem” and “pendulum drive arm” as utilized throughout this specification and within the claims are interchangeable terms referring to a rigid, stem-like portion of a non-regulatory pendulum drive commonly utilized in electromagnetically operated, quartz regulated pendulum drives.

As discussed above, the pendulum clock of the present invention may advantageously incorporate any conventional clockworks having a pendulum drive. In practicing the present invention, the clockworks serves as a means for pendulum movement as well as a means for operating hour and minute hands in the convention manner for the indication of time. For example, the plumbless, flexible pendulum of the present invention may be suspended and operated via a rigid pendulum drive arm of the afore-mentioned electric clocks incorporating electromagnetic pendulum drives. In such instances, a pendulum drive fixation means such as, for example, a hook, clip or strut, may be utilized to connect a superior end of the flexible pendulum (which is provided with a means of affixing said fixation means) to an inferior end of the pendulum drive arm whereat a means of attachment for the hook, clip or strut is provided. In enabling operation of an electromagnetic pendulum drive, the pendulum drive arm may include, for example, a ferrite magnet affixed or incorporated therewithin which passes in close proximity to coils within the clock works utilized to propel the arm through a controlled and well defined arc. The coils, is such embodiments, are utilized to sense the speed of the pendulum drive and control same as through controlled pulses of the electromagnet within the clock drive. As the pendulum drive are traverses the arc dictated by the coils controlling arm movement, the flexible pendulum suspended therebelow swings in a non-linear path. Since the suspended pendulum does not incorporate a plumb or any other attached weight, the centripetal force which would ordinarily cause the pendulum to produce a substantially linear radius through an arc of movement is absent. Therefore the pendulum is free to produce a curved form in response to the constant reversing motion of the pendulum drive. By carefully adjusting the length of the flexible pendulum, the weight of the material the pendulum is comprised of, or the power output of the pendulum drive, a visually pleasing curved pattern, such as, for example, a sigmoid pattern, is produced by the flexible chain.

As discussed above, the flexible pendulum may be advantageously comprised of a metallic or plastic ball, closed link or open link chain. In addition, the pendulum may be comprised of plastic beads, flexible line or any other non-rigid material capable of producing a curved pendulum conformation upon periodic pendulum movement.

Conventional clock drives, utilizing mechanical (non-electromagnetic) regulatory drives may also be utilized in practicing the present invention. In such instances, a two part pendulum of the present invention is advantageously comprised of a superior rigid portion coupled, via a coupling means, with an inferior flexible portion. A proximal (or superior) terminus of the rigid portion of the pendulum may thus advantageously include an anchor for engagement of an escapement gear of the regulatory drive. In such embodiments, the regulatory drive, by means of rotation of the engagement gear against the anchor provides arch like movement of the rigid portion of the two part pendulum. The flexible portion of the pendulum, coupled at its proximal terminus to the distal portion of rigid portion of the pendulum by means of a hook, string, cord or clip, is then swung in a back and forth movement. By adjusting the length and weight of the flexible portion of the pendulum, a curved configuration, such as an “S” curve, may be attained during clock operation.

As discussed above, the flexible portion of the pendulum may be affixed the rigid portion by means of a coupling means such as, for example, a hook, string, cord, clip or strut. Such coupling means may be advantageously utilized to mates with and engage a bore, groove, clip or other fixation means located adjacent to the distal terminus of the rigid portion of the pendulum and a corresponding bore, groove, clip located adjacent to a proximal terminus of the flexible portion of the pendulum.

### BRIEF DESCRIPTION OF THE DRAWINGS

FIG. 1 illustrates a rear view of a preferred embodiment of the present invention

FIG. 2 illustrates the preferred embodiment of FIG. 1 from a more distant perspective.

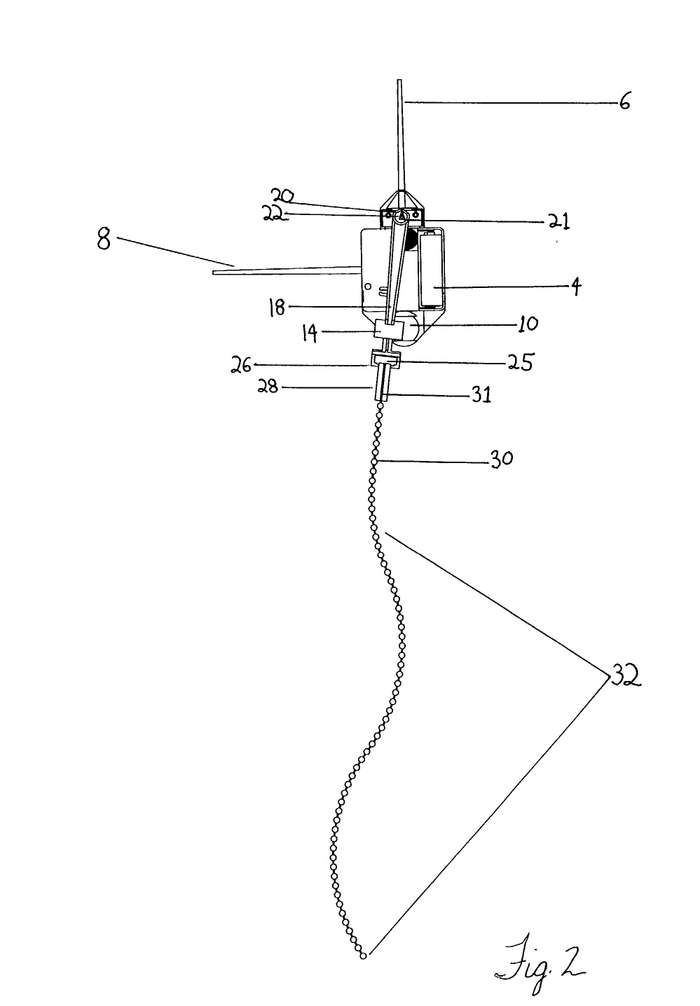

FIG. 3 is an exploded view of the preferred embodiment illustrated in FIGS. 1 and 2 shown from a rear/lateral perspective.

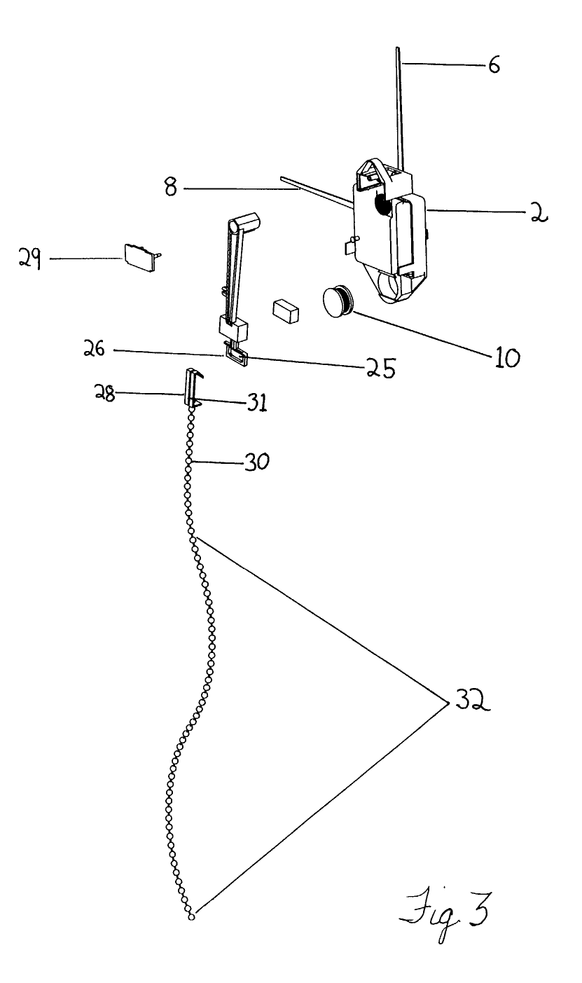

### DETAILED DESCRIPTION

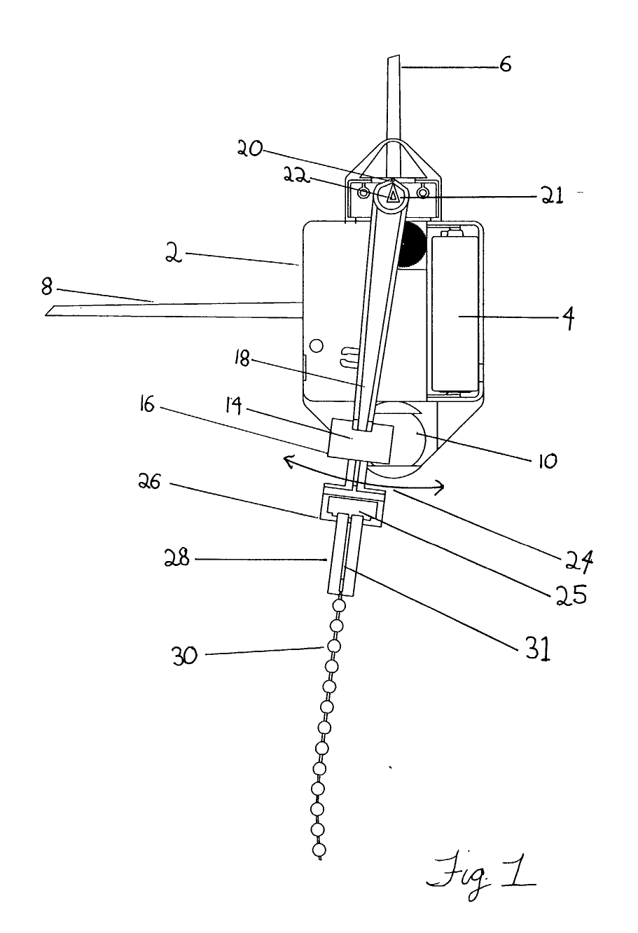

FIG. 1 illustrates a preferred embodiment of the present invention wherein the clockworks is an electric powered, quartz crystal regulated movement incorporating an electromagnetic pendulum drive. Clockworks housing 2 encases the electrically powered clock works utilizing power cell 4 as a source of electrical power. The electrically powered clockworks provides for time regulated movement of hour hand 6 as well as minute hand 8. The present invention also contemplates embodiments wherein the clockworks provides further and other time indicators such as second hands, moon position and tide indicators. It is also contemplated that the clock drive may operate digital time display as well as other ornamental indicators of time such as, for example, LED, LCD and mechanically operated printed digit cards. In addition to providing a regulated time display by means of the regulated movement of the afore-mentioned hour, minute and second hands, the clock drive housing 2 of the preferred embodiment illustrated in FIG. 1 also includes an electrical coil 10 which is positioned so as to be proximal to magnet 14 encased within blob 16. The term “blob” refers to an enlarged area of pendulum drive arm 18 which is contiguous with the arm and utilized as a means for positioning and encasing the magnet—and not as a plumb (pendulum weight) means. Proximal to a superior (or proximal) terminus 20 of the pendulum drive arm a bore 21 is provided for the purpose of suspending the drive arm from the clock housing. The bore may, as illustrated be provided with two converging planar walls on its superior surface for articulation with a pivoting/suspension means of the clock housing. In the preferred embodiment of the present invention illustrated in FIG. 1, a triangular extension 22 of the housing extends out from the housing, in order to provide a pivot for the drive arm. A corresponding triangular extension of cap 29 is provided for capture of the drive arm.

When energized by the power cell 4, current is pulsed to the electromagnetic coils so as to provide for periodic, arc like movement of the pendulum drive arm as indicated by arrow 24. Since the pendulum drive arm is comprised of a rigid material, the arm defines a linear radius of the arc provided by the movement of the distal terminus 26 of the drive arm. An example of a similar clock drive, suitable for use in practicing the present invention is the Hermle W-200 quartz pendulum clock manufactured by Franz Hermle & Son Clock Factory, Hermle Black Forest Clocks, 340 Industrial Park Drive, Amherst, 24521, Va.

Proximal to the inferior (or distal) terminus of the pendulum drive arm, a fixation means is provided for the attachment of the flexible pendulum. The fixation means may be, as illustrated in FIG. 1, a slot 25. The fixation means may also be, for example, a bore, groove, strut positioned proximal to the distal terminus of the arm. A suspension means, such as, for example, a hook 28, clip, cord or line is utilized to suspend a flexible pendulum 30 from the pendulum drive arm. The suspension means may advantageously incorporate a pendulum engagement means such as, for example slot 31 for attachment and suspension of the flexible chain.

The flexible pendulum is configured and comprised of any material so that the pendulum demonstrates sufficient flexibility to enable to formation of a curved pattern such as a sigmoid or “S” conformation 32 during the periodic movement of the pendulum drive arm. Suitable materials include, for example, metallic or plastic ball chain, link chain, strung beads, cords, strings and lines. In addition, such materials may be covered with decorative cloth or other materials so long as such does not increase the rigidity of the pendulum the point where a sigmoid or other curved shape can not be produced. The flexible pendulum utilized in the present invention, unlike the prior art, does not utilize a pendulum weight. Use of a pendulum weight would tend to tension the flexible pendulum so as to cause a more linear conformation.

The terms and expressions which have been employed in the foregoing specification are used therein as terms of description and not limitation, and there is no intention, in the use of such terms and expressions, of excluding equivalents of the features shown and described or portions thereof, it being recognized that the scope of the invention is defined and limited only by the following claims.

I claim:

1. A pendulum clock comprising:
a clockworks;
a pendulum drive,
a means for displaying time; and
a flexible, plumbless pendulum of a predetermined length and weight; said length and weight of said pendulum being especially selected so that when said clock is in operation, said pendulum drive causes said plumbless pendulum to produce a desired non-linear conformation.

2. The pendulum clock of claim 1 wherein the clockworks utilizes a mechanical power means.

3. The pendulum clock of claim 2 wherein the mechanical power means comprises a spring motor or weights.

4. The pendulum clock of claim 2 wherein the pendulum drive is a regulatory drive.

5. The pendulum clock of claim 4 wherein the flexible, plumbless pendulum is comprised of a superior rigid stem portion and a flexible inferior stem portion.

6. The pendulum clock of claim 5 wherein the superior and inferior stem portions are joined via coupling means.

7. The pendulum clock of claim 6 wherein the coupling means comprises a hook, string, cord or clip.

8. The pendulum clock of claim 7 wherein a fixation means is provided for said coupling means adjacent to a distal terminus of the rigid portion and adjacent to a proximal portion of the flexible portion of the plumbless pendulum.

9. The pendulum clock of claim 8 wherein said fixation means is a bore, groove, clip or strut.

10. The pendulum clock of claim 2 wherein the pendulum comprises a chain.

11. The pendulum clock of claim 10 wherein the chain is configured as a ball, closed link, or open link chain.

12. The pendulum clock of claim 11 wherein the chain is fabricated of metal or plastic.

13. The pendulum clock of claim 2 wherein the pendulum is comprised of a cord or string.

14. The pendulum clock of claim 2 wherein the non-linear conformation comprises an “s” shaped curve.

15. The pendulum clock of claim 2 wherein force applied by the pendulum drive to the flexible pendulum is especially selected so as to produce a non-linear pendulum conformation during clock operation.

16. The pendulum clock of claim 15 wherein the non-linear conformation comprises an “s” shaped curve.

17. The pendulum clock of claim 2 wherein said means for displaying time comprise hour and minute hands.

18. The pendulum clock of claim 2 wherein said means for displaying time comprise a digital display.

19. The pendulum clock of claim 1 wherein the clockworks is electrically powered.

20. The pendulum clock of claim 19 wherein the pendulum drive is a non-regulatory drive.

21. The pendulum clock of claim 20 wherein the pendulum drive comprises electromagnetic pendulum regulation.

22. The pendulum clock of claim 19 wherein the electrically operated clockworks utilizes an electronic regulatory means.

23. The pendulum clock of claim 22 wherein the electronic regulatory means comprises a quartz crystal.

24. The pendulum clock of claim 19 wherein the pendulum comprises a chain.

25. The pendulum clock of claim 24 wherein the chain is configured as a ball chain, closed link, or open link chain.

26. The pendulum clock of claim 25 wherein the chain is fabricated of metal or plastic.

27. The pendulum clock of claim 19 wherein the pendulum is comprised of a cord or string.

28. The pendulum clock of claim 19 wherein the non-linear conformation comprises an “s” shaped curve.

29. The pendulum clock of claim 19 wherein said means for displaying time comprises a minute and hour hand.

30. The pendulum clock of claim 19 wherein said means for displaying time comprises a digital display.

31. A pendulum clock comprising:
an electrically powered clockworks;
a electromagnetic pendulum drive;
a means for displaying time; and
a flexible, plumbless pendulum of a predetermined length and weight; said length and weight of said pendulum being especially selected so that when said clock is in operation, said pendulum drive causes said plumbless pendulum to produce a desired non-linear conformation.

32. The pendulum clock of claim 31 wherein the pendulum drive is a non-regulatory drive.

33. The pendulum clock of claim 31 wherein the electrically operated clockworks utilizes an electronic regulatory means.

34. The pendulum clock of claim 33 wherein the electronic regulatory means comprises a quartz crystal.

35. The pendulum clock of claim 31 wherein the pendulum comprises a chain.

36. The pendulum clock of claim 35 wherein the chain is configured as a ball chain, closed link, or open link chain.

37. The pendulum clock of claim 36 wherein the chain is fabricated of metal or plastic.

38. The pendulum clock of claim 31 wherein the pendulum is comprised of a cord or string.

39. The pendulum clock of claim 31 wherein the non-linear conformation comprises an “s” shaped curve.

40. The pendulum clock of claim 31 herein force applied by the pendulum drive to the flexible pendulum is especially selected so as to produce a non-linear pendulum conformation during clock operation.

41. The pendulum clock of claim 40 wherein the non-linear conformation comprises an “s” shaped curve.

42. The pendulum clock of claim 31 wherein the means for displaying time comprises an hour and minute hand.

43. The pendulum clock of claim 31 wherein the means for displaying time comprises a digital display.
